(19) United States
(12) Patent Application Publication
(10) Pub. No.: US 2007/0101053 A1
(43) Pub. Date: May 3, 2007

(54) Information recording apparatus and information recording method

(75) Inventor: Hirotaka Suzuki, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/514,258

(22) Filed: Sep. 1, 2006

(30) Foreign Application Priority Data
Oct. 31, 2005 (JP) 2005-317200

(51) Int. Cl. G06F 13/28

(52) U.S. Cl. 711/112

(57) ABSTRACT

According to one embodiment, a possible date and time at which a residual capacity of an information recording medium reaches a predetermined quantity is calculate and notified on the basis of a residual capacity of the information recording medium and a capacity consumed by the information recording medium based on set recording reservation information.

### CROSS-REFERENCE TO RELATED APPLICATIONS

This application is based upon and claims the benefit of priority from Japanese Patent Application No. 2005-317200, filed Oct. 31, 2005, the entire contents of which are incorporated herein by reference.

### BACKGROUND

1. Field

One embodiment of the invention relates to improvement of an information recording apparatus and an information recording method having a function for reserving and recording a television broadcast program or the like, for example.

2. Description of the Related Art

As is well known, in a recording and reproducing apparatus enabling recording reservation of a broadcast program by using a large capacity information recording medium such as, for example, a hard disk drive (HDD) or a digital versatile disk (DVD), recording of a number of programs can be reserved over a long period of time. For this reason, it is important to contrive management of a residual capacity of the information recording medium in view of the improvement of usability.

Jpn. Pat. Appln. KOKAI Publication No. 2003-33982 discloses a configuration of comparing a residual capacity of a hard disk with a capacity required for the reserved image recording at a time point of executing reserved image recording, and generating a warning message when it has been determined that the capacity is insufficient. However, in the Jpn. Pat. Appln. KOKAI Publication No. 2003-33982, a warning message is generated at a time point of execution of reserved image recording, so that a use has an enough time to cope with such a warning message, resulting in inconvenient handling.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a blow diagram depicting an embodiment of the present invention in order to explain a recording and reproducing apparatus;

FIG. 2 is a view adapted to explain a remote controller that controls the recording and reproducing apparatus in the embodiment;

FIG. 3 is a flow chart adapted to explain primary processing operations executed by the recording and reproducing apparatus in the embodiment;

FIG. 4 is a view adapted to explain an example of a recording reservation setting screen displayed by the recording and reproducing apparatus in the embodiment;

FIG. 5 is a view adapted to explain an example of a recording reservation list screen displayed by the recording and reproducing apparatus in the embodiment;

FIG. 6 is a view adapted to explain an example of a residual capacity display screen displayed by the recording and reproducing apparatus in the embodiment;

FIG. 7 is a view adapted to explain an example of a residual capacity setting screen displayed by the recording and reproducing apparatus in the embodiment;

FIG. 8 is a view adapted to explain an external view of a television receiver to which the present invention can be applied; and

FIG. 9 is a view adapted to explain an external view of a large screen type television receiver to which the present invention can be applied.

### DETAILED DESCRIPTION

Various embodiments according to the invention will be described hereinafter with reference to the accompanying drawings. In general, according to one embodiment of the invention, a possible date and time at which a residual capacity of an information recording medium reaches a predetermined quantity is calculate and notified on the basis of a residual capacity of the information recording medium and a capacity consumed by the information recording medium based on set recording reservation information.

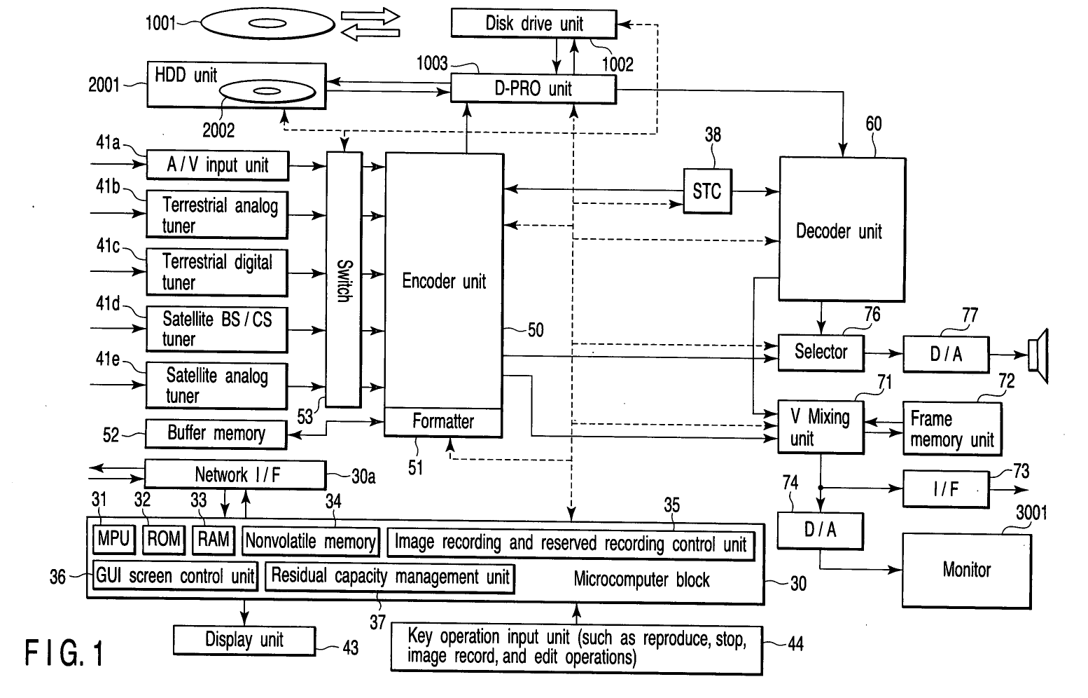

FIG. 1 shows an outline of a recording and reproducing apparatus explained in the present embodiment. The recording and reproducing apparatus shown in FIG. 1 is presented as an information recording medium capable of handling both of an optical disk such as a DVD and a hard disk. The information recording medium may be replaced with, for example, a semiconductor memory or the like.

In FIG. 1, when blocks are roughly divided, the left side indicates a main block of a recording unit, and the right side indicates a main block of a reproducing unit.

The recording and reproducing apparatus shown in FIG. 1 has two types of disk drive units, i.e., a disk drive unit 1002 and an HDD unit 2001. First, the disk drive unit 1002 rotationally drives an optical disk 1001 serving as a first medium that is an information recording medium capable of constructing a video file, and executes information read and write operations. The disk drive unit 1002 has a rotation control system, a laser drive system, an optical system and the like in response to the optical disk 1001. The HDD unit 2001 also drives a hard disk 2002 serving as a second medium.

A data processor unit 1003 can supply recording data to the disk drive unit 1002 and the HDD unit 2001 and can receive a reproduced signal. The data processor unit 1003 handles data defined in units of recording or reproduction, and includes a buffer circuit, a modulator/demodulator circuit, an error correcting circuit and the like.

In addition, the recording and reproducing apparatus shown in FIG. 1 primarily comprises an encoder unit 50 that configures a recording side; a decoder unit 60 that configures a reproducing side; and a microcomputer block 30 that controls an operation of the apparatus main body. The encoder unit 50 includes a transport stream processor unit and a plurality of encoders.

The encoder unit 50 has: video and audio analog digital converters that basically digitize inputted analog video signals or analog audio signals; a video encoder; and an audio encoder. The encoder unit further includes a sub picture encoder.

An encode output from the encoder unit 50 is converted into a predetermined DVD-RAM (random access memory) format at a formatter 51 that includes a buffer memory 52, and the converted encode output is supplied to the data processing unit 1003 that precedes the encoder unit. A packet elementary stream extracted from a transport stream may be recorded from the encoder unit 50 directly to the hard disk 2002 of the HDD unit 2001.

An external analog video signal and an external analog audio signal obtained from an audio/video (A/V) input unit 41a can be inputted to the encoder unit 50 via a switch 53.

In addition, signals received from a terrestrial analog tuner 41b, a terrestrial digital tuner 41c, a satellite broadcasting satellite (BS)/communication satellite (CS) tuner 41d, and a satellite analog tuner 41e can be selectively inputted to the encoder unit 50 via the switch 53.

In the case where a plurality of encoders are utilized at the encoder unit 50, a program received by the terrestrial digital tuner 41c is recorded in the hard disk 2002 at the HDD unit 2001, and at the same time, a program received at the satellite BS/CS tuner 41d can be viewed.

When compressed digital video signals or digital audio signals are directly inputted, the encoder unit 50 can supply the compressed digital video signals or digital audio signals directly to the formatter 51. The encoder unit 50 can also supply analog/digital converted digital video signals or audio signals directly to a video (V) mixing unit 71 or an audio selector 76.

In a moving picture experts group (MPEG) video encoder included in the encoder unit 50, a digital video signal is converted into a digital video signal compressed at a variable bit rate under an MPEG2 or MPEG1 standard.

The digital audio signal is converted into a digital audio signal compressed at a fixed bit rate under an MPEG or audio compression (AC)-3 standard or a linear pulse code modulation (PCM) digital audio signal.

In the case where a sub picture signal (such as, for example, a signal from a DVD video player with an independent output terminal of a sub picture signal) has been inputted from the A/V input unit 41a or in the case where a DVD video signal having such a data structure has been broadcasted, and then, the broadcast signal has been received at a television (TV) tuner unit (not shown), a sub picture signal included in a DVD video signal is encoded (run-length encoded) by means of a sub picture encoder, and the encoded signal is obtained as a bit map of a sub picture.

The encoded digital video signals, digital audio signals, and sub picture data are packed at the formatter 51 to be produced as a video pack, an audio pack, and a sub picture pack. Further, these packs are collected and converted into a format specified in the DVD-video standard (DVD Video format) or a format specified in a DVD recording standard (DVD VR format). The formatter 51 also utilizes the buffer memory 52 when the above-described converting processing is made.

The recording and reproducing apparatus shown in FIG. 1 can supply information (packs of video, audio, sub picture data and the like) formatted by the formatter 52 and produced management information to the HDD unit 2001 or the disk drive unit 1002 via the data processor unit 1003 and can record these items of information in the hard disk 2002 or the optical disk 1001.

In addition, the apparatus can record the information recorded in the hard disk 2002 or the optical disk 1001 in the optical disk 1001 or the hard disk 2002 by using the data processor unit 1003 and the disk drive unit 1002.

Further, the apparatus can carry out edit processing such as partially deleting video objects of a plurality of programs recorded in the hard disk 2002 or the optical disk 1001 and connecting objects of different programs.

The microcomputer block 30 includes: a micro processor unit (MPU) 31 [or central processing unit (CPU)]; a read only memory (ROM) 32 having written into a control program or the like executed by the MPU 31; a RAM 33 for providing a work area required for executing a program; and a nonvolatile memory 34 for storing a variety of control information and setting information, etc.

The microcomputer block 30 can be connected to an external network via a network interface (I/F) 30a. In this way, this block can capture a dynamic electronic program guide (DEPG) from an external server.

Further, the MPU 31 of the microcomputer block 30 executes faulty location detection, unrecorded region detection, recording information or recording position setting, a universal disk format (UDF) recording, an AV address setting and the like by using the RAM 32 as a work area on the basis of the control program stored in the ROM 32.

The microcomputer block 30 also has a variety of information processing units required to integrally control blocks of the recording and reproducing apparatus. These information processing units include a directly detector unit, a video manager (VMG) information (whole video management information) producing unit, a copy-related information sensor unit, a copy and scrambling information (RDI) processing unit, a packet header processing unit, a sequence header processing unit, and an aspect ratio information processing unit, although not shown, as well as a work RAM 33.

Further, the microcomputer block 30 is provided with a program reservation and recording control unit 35, a graphical user interface (GUI) screen control unit 36, and a residual capacity managing unit 37 that manages the residual capacity relevant to the hard disk 2002.

Among them, the program reservation and recording control unit 35 controls an operation of recording a program based on program recording reservation settings or its related recording reservation. Program recording reservation is carried out in such a manner that the monitor display 3001 is caused to display a recording reservation setting screen for inputting recording reservation information such as a broadcasting (recording) date, a starting time and an ending time, a broadcast channel, a recording destination, and a compression and encoding mode on a program by program basis, the programs being targeted for recording, and then a predetermined item is inputted on that screen. The inputted recording reservation information is recorded by being stored in the nonvolatile memory 34. Then, based on the recording reservation information stored in the nonvolatile memory 34, a recording operation is automatically made when a program starting time has expired.

Among a result of execution of the microcomputer block 30, the contents to be notified to a user are displayed on the display unit 43 of the recording and reproducing apparatus or OSD (on screen display) displayed on the monitor display 3001.

The microcomputer block 30 has a key operation input unit 44 that assigns an operating signal for operating the recording and reproducing apparatus. This key operation input unit 44 corresponds to operating switches provided on a main body of the recording and reproducing apparatus, a remote controller 20 to be described later, or the like. In addition, this input unit may be a personal computer (PC) connected to the recording and reproducing apparatus by using means such as wired communication or wireless communication (including optical communication or infrared-ray communication). In any mode, a user can apply a processing of recording inputted video and voice signals, a processing of reproducing recorded contents, or a processing of editing recorded contents, by operating the key operation input unit 44.

A timing of the microcomputer block 30 controlling the disk drive unit 1002, the HDD unit 2001, the data processor unit 1003, the encoder unit 50 and/or decoder unit 60 can be executed on the basis of time data from a system time clock (STC) 38. While a recording or reproducing operation is generally executed in synchronism with a time clock from the STC 38, the other processing may be executed at a timing independent from the STC 38.

The decoder unit 60 has: a separator that separates and removes packs from a signal conforming to a DVD format having a pack structure; a memory used at the time of pack separation or execution of another signal processing; a V decoder that decodes main picture data (contents of video pack) separated by the separator; a sub picture (SP) decoder that decodes sub picture data (contents of sub picture pack) separated by the separator; and an audio (A) decoder that decodes audio data (contents of audio pack) separated by the separator. In addition, this decoder unit comprises a video processor that properly combines a decoded sub picture with a decoded main picture and outputs a menu, a highlight button, a subtitle, or other sub pictures to be superimposed on the main picture.

An output video signal of the decoder unit 60 is inputted to the V mixing unit 71. The V mixing unit 71 combines text data, for example. In addition, a line for directly capturing a signal from the above TV tuner unit or A/V input unit 41a is also connected to the V mixing unit 71. A frame memory unit 72 used as a buffer is connected to the V mixing unit 71. In the case where an output of the V mixing unit 71 is an analog output, the analog output is externally outputted vi an interface (I/F) 73. In the case where the above output is a digital output, this digital output is externally outputted via a digital/analog converter 74.

An output audio signal of the decoder unit 60 is analogue-converted by a digital/analog converter 77 via an audio selector 76, and the converted signal is externally outputted. The audio selector 76 is controlled by a select signal from the microcomputer block 30. In this manner, the audio selector 76 can select an audio signal through the encoder unit 50 directly, when a digital signal from the above TV tuner unit or A/V input unit 41a is directly monitored.

The formatter 51 of the encoder unit 50 produces each item of isolation information during recording, and then, periodically sends the produced information [GOP (group of picture) head interruption time information or the like] to the MPU 31 of the microcomputer block 30. The isolation information includes: the number of video object unit (VOBU) packs, an end address of I (intra) picture from the head of VOBU, and VOBU reproduction time.

At the same time, information from the aspect ratio information processing unit (not shown) is sent to the MPU 31 when recording starts, and the MPU 31 produces video object (VOB) stream information (STI). Here, with respect to STI, resolution data, aspect data or the like is stored, and, at the time of reproduction, initial setting is provided at each decoder unit based on the information.

In addition, in this recording and reproducing apparatus, one video file is recorded and stored in a DVD on a one by one disk basis. Further, while accessing (seeking) data, a minimum of continuous information unit (size) is determined in order to continue reproduction without any intermittence. This unit is referred to as a continuous data area (CDA). The CDA size is a multiple of an error correcting code (ECC) block (16 sectors), and recording is carried out in this CDA unit in a file system.

The data processor unit 1003 receives data defined in VOBU unit from the formatter 51 of the encoder unit 50, and supplies the data defined in CDA unit to the disk drive unit 1002 or the HDD unit 2001.

In addition, the MPU 31 of the microcomputer block 30 produces management information required to reproduce recorded data, recognizes a command indicating the end of data recording, and then, sends the produced management information to the data processor unit 1003. In this manner, the management information is recorded in the optical disk 1001 or the hard disk 2002. Consequently, while encoding is carried out, the MPU 31 of the microcomputer block 30 receives data unit information (such as isolation information) from the encoder unit 50.

Further, the MPU 31 of the microcomputer block 30 recognizes management information (file system) read from the optical disk 1001 and the hard disk 2002 when recording starts, and recognizes an unrecorded area of each disk, thereby setting a data recording area in a disk via the data processor unit 1003.

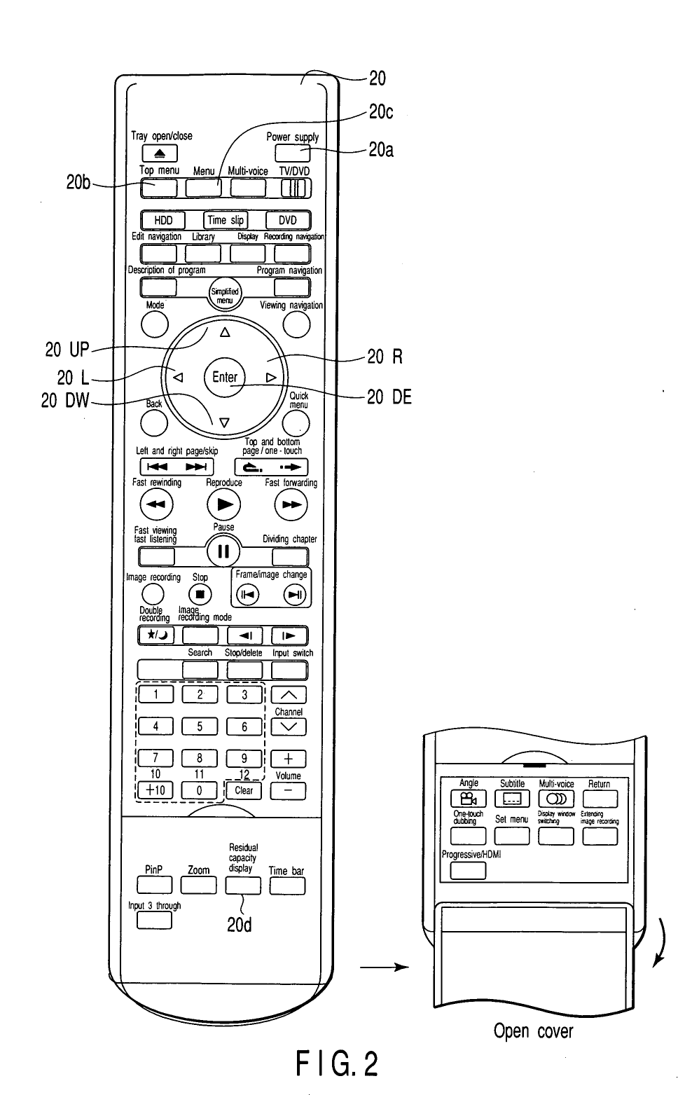

FIG. 2 shows an external view of the above remote controller 20. Referring to primary operating keys, reference numeral 20a denotes a power supply key for turning ON/OFF power, and reference numeral 20b denotes a top menu key for displaying a top menu screen. In addition, a menu key 20c serves as an operating key to be operated when displaying a menu recorded in an information recording medium such as a DVD. Further, reference numeral 20DE denotes an enter key, and reference numerals 20UP, 20DW, 20R, and 20L denote cursor operating keys for moving the cursor displayed on a screen to UP, DOWN, RIGHT, and LEFT. Moreover, a residual capacity display key 20d for displaying the residual capacity of the hard disk 2002 is arranged.

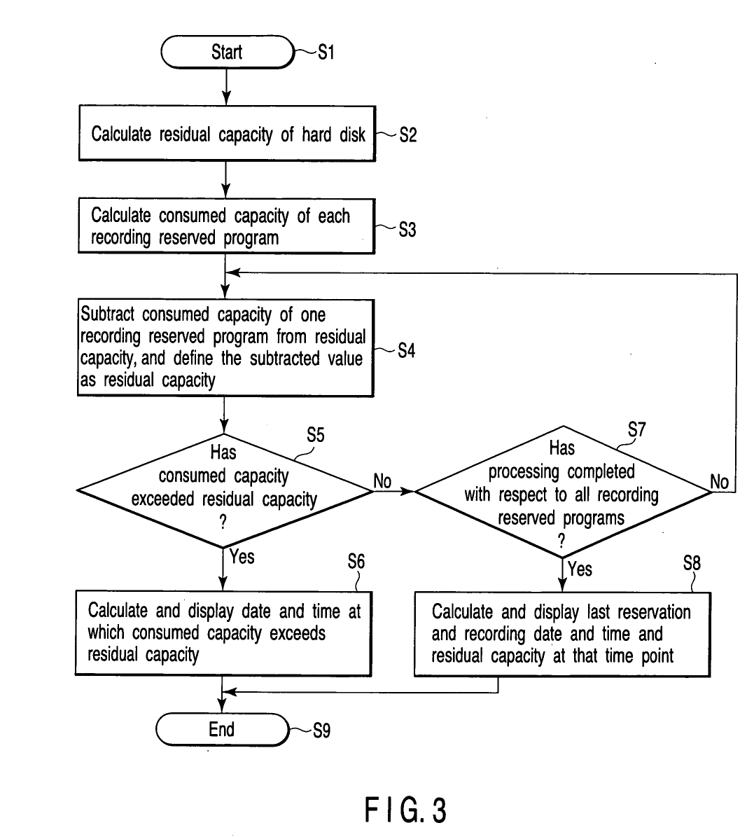

Now, with reference to a flow chart shown in FIG. 3, a description will be given with respect to a characterizing processing operation relevant to the residual capacity management unit 37 of the microcomputer block 30. In the processing operation, a description will be given assuming that a number of recording reserved programs have been sequentially recorded in the hard disk 2002 of the HDD unit 2001.

First, when a processing operation is started at a predetermined timing (block S1), the microcomputer block 30 calculates the residual capacity that currently enables recording in the hard disk 2002 in block S2.

Next, in block S3, the microcomputer block 30 calculates the capacity of the hard disk 2002 that is consumed on a recording reserved program by program basis, on the basis of the recording reservation information stored in the nonvolatile memory 34.

Thereafter, in block S4, the microcomputer block 30 subtracts the capacity of the hard disk 2002 that consumed in, for example, a program in which reserved recording is executed on a time base from the residual capacity that enables recording in the hard disk 2002. In block S5, this block determines whether or not the consumed capacity exceeds the residual capacity of the hard disk 2002.

When it is determined that the consumed capacity exceeds the residual capacity (YES), the microcomputer block 30 calculates in block S6 a date and time at which the consumed capacity exceeds the residual capacity of the hard disk 2002, namely, a date and time at which the residual capacity of the hard disk 2002 becomes 0%. After that date and time has been notified to a user by displaying it on the monitor display 3001, processing is terminated (block S9).

On the other hand, when the consumed capacity does not exceed the residual capacity of the hard disk 2002 in the block S5 (NO), the microcomputer block 30 in block S7 determines whether or not a processing of subtracting the capacity consumed in reserved recording of the program from the residual capacity of the hard disk 2002 with respect to all the recording reservation information stored in the nonvolatile memory 34 has completed.

When it is determined that the above processing does not complete (NO), the microcomputer block 30 reverts to the processing in block S4 in which control is first made so as to further subtract the capacity consumed in a program in which reservation and recording are then executed on a time base from the residual capacity of the hard disk 2002 whose consumed capacity has been subtracted.

On the other hand, when it is determined that the subtracting processing completes in the block S7 (YES), the microcomputer block 30 causes in block S8 the monitor display 3001 to display a date and time at which reserved recording is lastly executed on a time base and the residual capacity of the hard disk 2002 at that time point, thereby notifying the user of the fact, and terminates processing (block S9).

According to the above-described embodiment, a date and time at which the residual capacity of the hard disk 2002 becomes 0% is displayed on the basis of recording reservation information. Thus, the user can recognize in advance moving or deleting the data recorded in the hard disk 2002 to another information recording medium (such as the optical disk 1001, for example). That is, the user can have a sufficient time base margin for counteracting the shortage of the residual capacity, and the user's handling can be made convenient.

In particular, in the case where mode setting “everyday” or “every week” has been provided to a specific time interval in order to make recording reservation of a program to be periodically broadcast, failure to check recording and reservation often occurs, and the capacity of the hard disk 2002 is exceeded without any notice, so that data may be overwritten.

In such a case as well, as long as a date and time at which the capacity of the hard disk 2002 is exceeded is known in advance, data processing on the hard disk 2002 can be carried out until the date and time at which the capacity is exceeded has expired. In this way, by displaying a possible date and time at which the residual capacity of the hard disk 2002 becomes 0%, data management (store, move, and delete) on the hard disk 2002 can be facilitated when the user uses the recording and reproducing apparatus.

Now, a description will be given with respect to a timing of calculating and displaying a possible date and time at which the residual capacity of the hard disk 2002 becomes 0%, as described above. This timing includes: a time point of newly setting (adding) recording reservation information; a time point of displaying a list of the set recording reservation information; and a time point of displaying the residual capacity of the hard disk 2002.

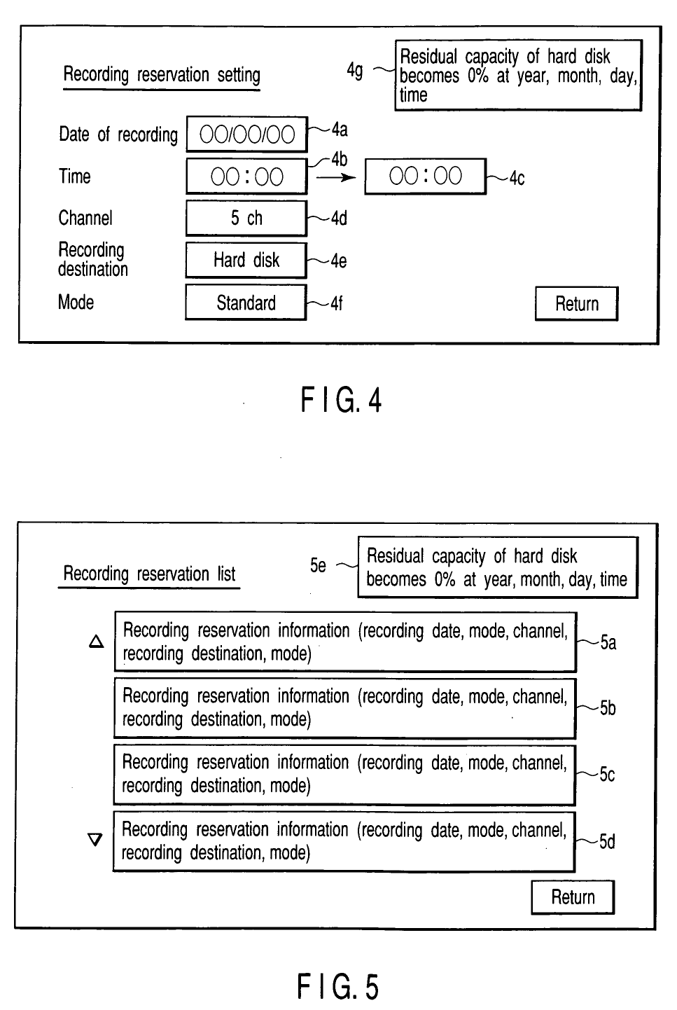

FIG. 4 shows an example of a recording reservation setting screen for providing recording reservation information setting. The recording reservation setting screen is displayed by displaying a top menu by operating the top menu key 20b of the remote controller 20, and entering a variety of menu screens provided as a hierarchical structure from the top menu.

The recording reservation setting screen displays: a broadcast (recording) date for recording reservation; a starting time and an ending time; a broadcast channel; a recording destination; variety of items 4a to 4f for inputting recording reservation information such as a compression and encoding mode; and an item 4g for giving notice of a possible date and time at which the residual capacity of the hard disk 2002 becomes 0%. The content of notification of the date and time relevant to the item 4g includes, for example, a message that “the residual capacity of the hard disk becomes 0% at year, month, day, time”.

In this case, while recording reservation information is inputted on the recording reservation setting screen, the date and time is calculated and displayed again in the case where a date and time calculated beforehand based on the recording reservation information stored in the nonvolatile memory 34 is displayed, and the inputted recording reservation information is stored in the nonvolatile memory 34, namely, in the case where regular recording reservation information are newly registered (added).

FIG. 5 shows an example of a list screen of the recording reservation information stored in the nonvolatile memory 34. The recording reservation list screen is also displayed by displaying a top menu while operating the top menu key 20b of the remote controller 20, and entering a variety of menu screens provided as a hierarchical structure from the top menu.

The recording reservation list screen displays items 5a to 5d indicating a plurality of recording reservation information (four items of information as shown) and displays an item 5e for giving notice of a possible date and time at which the residual capacity of the hard disk 2002 becomes 0%. The content of notification of the date and time relevant to the item 5e include a message that “the residual capacity of the hard disk becomes 0% at year, month, day, time” or the like. On the recording reservation list screen, the screen is scrolled in a vertical direction by operating the cursor operating keys 20UP and 20DW of the remote controller 20, whereby recording reservation information on a portion not displayed can be seen.

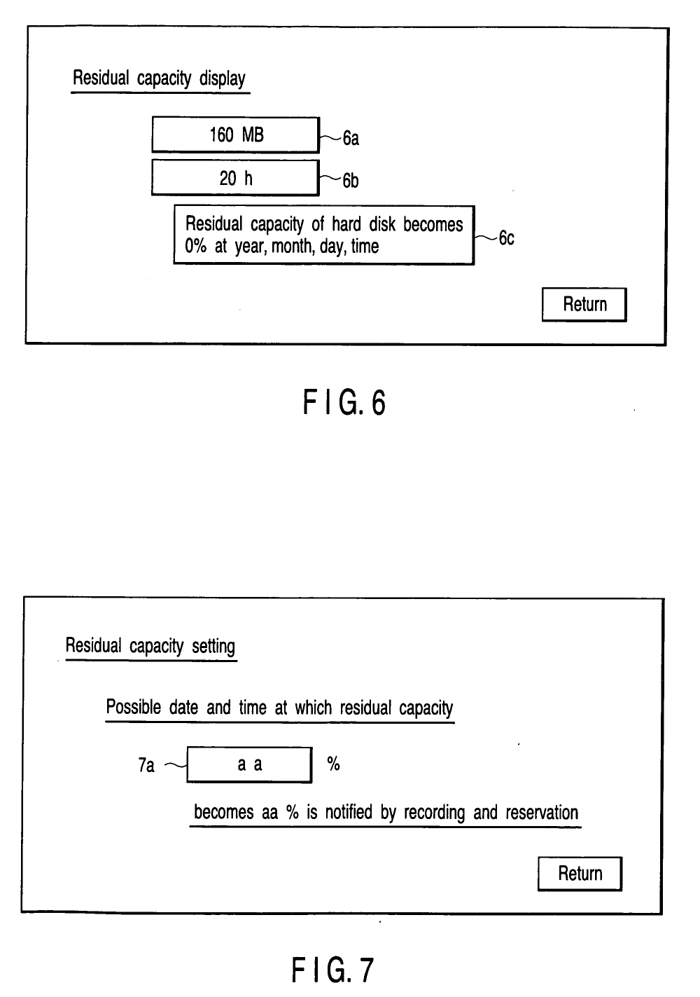

FIG. 6 shows an example of a residual capacity display screen that displays the residual capacity of the hard disk 2002. The residual capacity display screen is displayed by operating the residual capacity display key 20d of the above-described remote controller 20.

The residual capacity display screen displays an item 6a indicating the residual capacity in units of bytes and an item 6b indicating the residual capacity converted into a recording time, and displays an item 6c for giving notice of a possible date and time at which the residual capacity of the hard disk 2002 becomes 0%. The content of notification of the date and time relevant to the item 6c includes a message that “the residual capacity of the hard disk becomes 0% at year, month, day, time” or the like.

The foregoing embodiment has described that the possible date and time at which the residual capacity of the hard disk 2002 becomes 0% is calculated and notified, but not limited thereto. For example, a possible date and time at which the residual capacity of the hard disk 2002 becomes a preset predetermined quantity may be calculated and notified. In this case, the residual capacity of the hard disk 2002 that is defined as a condition for calculating the predetermined date and time can be arbitrarily set by the user.

FIG. 7 shows an example of a residual capacity setting screen for setting the residual capacity of the hard disk 2002 that is defined as a condition for calculating the possible date and time. The residual capacity setting screen is displayed by displaying a top menu by operating the top menu key 20b of the remote controller 20, and entering a variety of menu screens provided as a hierarchical structure from the top menu.

The residual capacity setting screen displays an item 7a for inputting, by %, the residual capacity of the hard disk 200 defined as a condition for calculating the possible date and time. In addition, a message that “a possible date and time at which the residual capacity becomes aa % is notified by recording reservation” is displayed in response to a value “aa” inputted to the item 7a, and the meaning of inputting a numeric value is explained to the user.

In the case where the residual capacity has been set at, for example, 30% in the residual capacity setting screen, the content of notification of the date and time shown in FIGS. 4 to 6 is changed to a message that “the residual capacity of the hard disk becomes 30% at year, month, day, time”. The residual capacity set on the residual capacity setting screen is stored in the nonvolatile memory 34.

In the case where a change or a deletion occurs with the recording reservation information stored in the nonvolatile memory 34 or in the case where the data recorded in the hard disk 2002 is deleted and the residual capacity is changed, the date and time may be displayed by recalculating it every time.

In addition, for example, in the case where the user has carried out program recording or recording time shifting by manual operation, no recording reservation information changes, and thus, a shift occurs with the possible date and time to be calculated. Therefore, for example, the possible date and time may be calculated and displayed at a time point at which a program recording operation has terminated or periodically in units of several hours, on the basis of the residual capacity of the hard disk 2002 and recording reservation information.

In addition, when the possible date and time at which the residual capacity of the hard disk 2002 becomes a predetermined quantity is calculated and displayed on the basis of the residual capacity of the hard disk 2002 and the recording reservation information, it is possible to determine from which recording reserved program the residual capacity of the hard disk 2002 becomes a predetermined quantity, namely, from which recording reserved program to disable recording. For this reason, displaying that recording reserved program together with the possible date and time becomes convenient for user handling.

Types of recording reservation include: weekly reservation for reserving record of the same series of programs broadcast in units of one week; daily reservation for reserving record of the same series of programs broadcast daily; EPG reservation for reserving record of a specific program only once; and mixed reservation in which weekly reservation, daily reservation, and EPG reservation coexist.

A timing of displaying a possible date and time at which the residual capacity of the hard disk 2002 becomes a predetermined quantity includes: in addition to the time of setting recording reservation, the time of displaying a recording reservation list, and a time of displaying the residual capacity, calculating and displaying a possible date and time every time on the basis of an increase of consumed capacity during a recording operation; calculating and displaying a possible date and time on the basis of recording reservation information that is currently recorded at the time of reproduction; and providing a window for displaying a possible date and time on a screen, and displaying the possible date and time every time.

Further, apart from calculating and displaying a possible date and time at which the residual capacity of the hard disk 2002 becomes a predetermined quantity (0%, 30% or the like), it is considered to calculate and display a period of time required for the residual capacity of the hard disk 2002 to reach a predetermined quantity or the number of programs that can be recorded. For example, it is possible to calculate and display information on how many % or how many days are required for the residual capacity of the hard disk 2002 to reach a predetermined quantity or how many programs can be recorded.

In the case where a possible date and time at which the residual capacity of the hard disk 2002 becomes a predetermined quantity is earlier than a predetermined period of time, the possible date and time display may not be set. For example, in the case where a possible date and time at which the residual capacity of the hard disk 2002 is 6 months or later, the possible date and time display may not be set. In this case, the user can set a period of time at which the possible date and time has been reached as 3 month or later, 1 month or later, or 1 week or later.

Furthermore, a method for displaying a possible date and time may include: character information display, dedicated panel display, color based display (displaying date and time by red in the case where possible date and time is the day after; displaying date and time by yellow in the case where possible date and time is 3 days later, displaying date and time in the case where possible date and time is 1 week or later); notifying a user's PC or portable cellular phone of a possible date and time via E-mail.

The foregoing embodiment has described recording a program in the hard disk 2002, but not limited thereto. The recording and reproducing apparatus can record a program in an optical disk 1001 or can cause a recording device to record a program by specifying the recording device corrected to an external network. In such a case as well, of course, a possible date and time at which the residual capacity of an information recording medium becomes a predetermined quantity can be calculated and displayed.

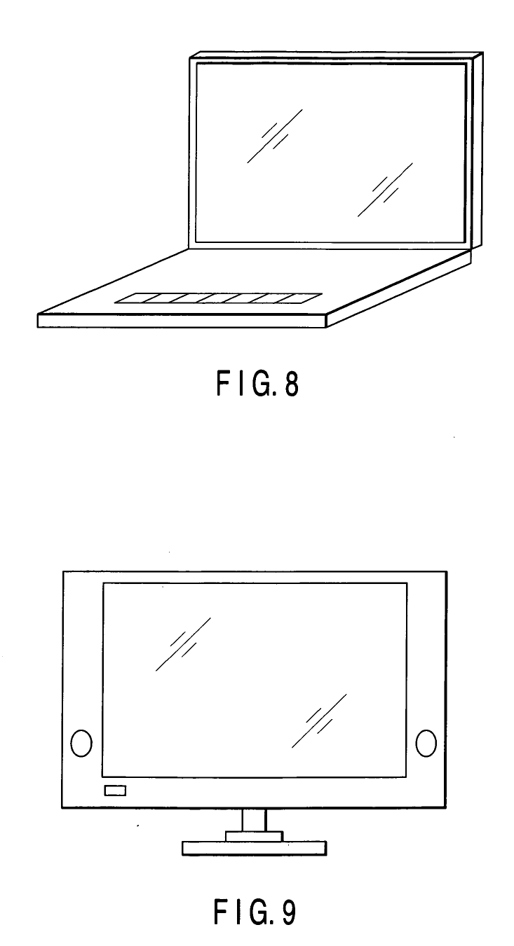

Moreover, the present invention can be widely used for a recording and reproducing apparatus or the like for voice information only; a mobile television receiver shown in FIG. 8, and a large screen type television receiver shown in FIG. 9, as well as an HDD built-in DVD recorder.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a residual capacity calculating unit configured to calculate a residual capacity of an information recording medium;
a consumed capacity calculating unit configured to calculate a capacity consumed by the information recording medium on the basis of set recording reservation information;
a date and time calculating unit configured to calculate a possible date and time at which the residual capacity of the information recording medium reaches a predetermined quantity on the basis of the residual capacity calculated at the residual capacity calculating unit and the consumed capacity calculated at the consumed capacity calculating unit; and
a notifying unit configured to give notice of the date and time calculated at the date and time calculating unit.

2. An information recording apparatus according to claim 1, wherein the date and trim calculating unit is configured to, when a possible date and time at which the residual capacity of the information recording medium reaches a predetermined quantity cannot be calculated, output to the notifying unit a date and time of reserved recording executed lastly on a time base, and
the notifying unit is configured to give notice of the date and time of reserved recording executed lastly on a time base, the date and time being supplied from the date and time calculating unit.

3. An information recording apparatus according to claim 1, wherein the date and time calculating unit comprises a setting unit configured to set a residual quantity of the information recording medium defined as a condition for calculating a date and time, and is configured to calculate a possible date and time at which the residual capacity of the information recording medium reaches a predetermined quantity set at the setting unit.

4. An information recording apparatus according to claim 1, wherein the notifying unit is configured to give notice of a date and time at the time of setting the recording reservation information.

5. An information recording apparatus according to claim 1, wherein the notifying unit is configured to give notice of a date and time at the time of displaying a list of the recording reservation information.

6. An information recording apparatus according to claim 1, wherein the notifying unit is configured to give notice of a date and time at the time of displaying a residual capacity of the information recording medium.

7. An information recording apparatus according to claim 1, wherein the notifying unit is configured to give notice of a date and time at the time of reproduction of the information recording medium.

8. An information recording apparatus according to claim 1, wherein the notifying unit is configured not to give notice of a date and time when the date and time calculated at the date and time calculating unit is earlier than a predetermined period of time.

9. An information recording apparatus according to claim 1, wherein the date and time calculating unit is configured to determine from which recording reserved program the residual capacity of the information recording medium becomes a predetermined quantity, and
the notifying unit is configured to give notice of a recording reserved program determined at the date and time calculating unit.

10. An information recording apparatus according to claim 1, wherein the date and time calculating unit is configured to calculate a period of time required for the residual capacity of the information recording medium to reach a predetermined quantity, and
the notifying unit is configured to give notice of a period of time calculated at the date and time calculating unit.

11. An information recording method comprising:
a residual capacity calculating block of calculating a residual capacity of an information recording medium;
a consumed capacity calculating block of calculating a capacity consumed by the information recording medium on the basis of set recording reservation information;
a date and time calculating block of calculating a possible date and time at which the residual capacity of the information recording medium reaches a predetermined quantity on the basis of the residual capacity calculated in the residual capacity calculating block and the consumed capacity calculated in the consumed capacity calculating block; and
a notifying block of giving notice of the date and time calculated in the date and time calculating block.

12. An information recording method according to claim 11, wherein the date and trim calculating block outputs a date and time of reserved recording executed lastly on a time base when a possible date and time at which the residual capacity of the information recording medium reaches a predetermined quantity cannot be calculated, and
the notifying unit block gives notice of the date and time of reserved recording output in the date and time calculating block.
